(19) United States
(12) Patent Application Publication
(10) Pub. No.: US 2007/0147771 A1
(43) Pub. Date: Jun. 28, 2007

(54) Recording and reproducing apparatus and programmed recording method thereof

(75) Inventor: Shojiro Fujimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/642,556

(22) Filed: Dec. 21, 2006

(30) Foreign Application Priority Data
Dec. 27, 2005 (JP) P2005-375044

(51) Int. Cl. H04N 5/91

(52) U.S. Cl. 386/83

(57) ABSTRACT

A recording and reproducing apparatus is operable to set a programmed recording of a television program. A recording date setting section sets a recording date of the programmed recording to a date of a day on which the programmed recording is set when the programmed recording is commanded. A recording start time setting section sets a recording start time based on the current time. A recording time input section inputs recording time of the programmed recording. A recording ending time setting section sets a recording ending time of the programmed recording to a time obtained by adding the recording time input by the recording time input section to the recording start time. A recording channel setting section sets the recording channel of the programmed recording to a channel which is currently received. A recording data compression ratio setting section sets the recording data compression ratio of the programmed recording. A programmed recording setting section stores the recording date, the recording start time, the recording ending time, the recording channel, and the recording data compression ratio and sets the programmed recording based on the stored recording date, the stored recording start time, the stored recording ending time, the stored recording channel, and the stored recording data compression ratio.

The disclosure of Japanese Patent Application No. 2005-375044 filed Dec. 27, 2005 including specification, drawings and claims is incorporated herein by reference in its entirety.

### BACKGROUND OF THE INVENTION

This invention relates to a recording and reproducing apparatus and a programmed recording method thereof. for enabling an user to set a programmed recording of a TV program.

In related-art recording and reproducing apparatus, in order to set a programmed recording of a desired TV program, the user enters a G code (registered trademark of USA Jem Star) in TV schedules of a newspaper, etc to the recording and reproducing apparatus. However, since the G code is made up of several digits, when the G code is entered, there is a problem that an entry mistake of the digits of the G code may occur. In another related-art recording and reproducing apparatus, the initial value of the recording stat time is set as the current time, the initial value of the recording ending time is set as one hour after the recording start time, and the initial value of the recording data compression ratio as the currently setup recording data compression ratio when a user sets the programmed recording. However, when the user changes the recording data compression ratio, since the free space amount of a recording medium is unknown, it takes time and labor to set the recording data compression ratio. Therefore, there is a problem that an entry mistake of the setup value of the recording data compression ratio may occur, and the latter half of the TV program may be not recorded.

As a related-art, there is an apparatus which sets the programmed recording when the user presses a programmed recording key, by setting a recording channel to a channel which is currently received, determining the TV program type from a time when the programmed recording key is pressed, and calculating the recording start time and the recording time. (For example, refer to Japanese Patent Publication No. 06-290510.)

There is also a related-art apparatus which sets the programmed recording by receiving and displaying a name of the TV program, a broadcasting channel, a broadcasting start time, and a broadcasting ending time, and allowing the user to select the displayed name of the TV program, and broadcast channel. (For example, refer to Japanese Patent Publication No. 09-180291.)

Furthermore, there is also a related-art apparatus which sets the programmed recording by setting the data compression ratio to a data compression ratio which allows a recording medium to store all of the TV programs which is set to programmed recording according to the free space amount of the recording medium, in a case where the data compression ratios of the TV programs are not set. (For example, refer to Japanese Patent Publication No. 10-092106.)

However, in Japanese Patent Publication No. 06-290510, there is a problem that the user cannot set a TV program such as a special program different from the TV program in the same time period to the programmed recording.

In Japanese Patent Publication No. 09-180291, there is a problem that the user cannot set the TV program to the programmed recording unless information of the TV program is received.

In Japanese Patent Publication No. 10-092106, since the data compression ratio is changed so that all of the TV programs which is set to the programmed recording can be stored in the free space amount of the recording medium, there is a problem that the user cannot set the desired data compression ratio (for example, a data compression ratio for high image quality).

### SUMMARY OF THE INVENTION

It is therefore an object of the invention to provide a recording and reproducing apparatus and a programmed recording method thereof for enabling the user to easily set the apparatus to programmed recording of any desired TV program by simple operation.

In order to achieve the above described object, according to the invention, there is provided a recording and reproducing apparatus operable to set a programmed recording of a television program, the recording and reproducing apparatus comprising:

a recording date setting section, which sets a recording date of the programmed recording to a date of a day on which the programmed recording is set when the programmed recording is commanded;

a recording date changing section, which changes the recording date set by the recording date setting section;

a recording start time setting section, which sets a recording start time based on the current time;

a recording start time changing section, which changes the recording start time set by the recording start time setting section;

a recording time input section, which inputs recording time of the programmed recording;

a recording ending time setting section, which sets a recording ending time of the programmed recording to a time obtained by adding the recording time input by the recording time input section to the recording start time;

a recording ending time changing section, which changes the recording ending time set by the recording ending time setting section;

a recording channel setting section, which sets the recording channel of the programmed recording to a channel which is currently received;

a recording channel changing section, which changes the recording channel set by the recording channel setting means;

a recording data compression ratio setting section, which sets the recording data compression ratio of the programmed recording;

a recording data compression ratio changing section, which changes the recording data compression ratio set by the recording data compression ratio setting section;

a programmed recording setting section, which stores the recording date, the recording start time, the recording ending time, the recording channel, and the recording data compression ratio and sets the programmed recording based on the stored recording date, the stored recording start time, the stored recording ending time, the stored recording channel, and the stored recording data compression ratio.

The recording start time setting section may set the recording start time to the next rounded hour from the current time.

The recording start time setting section may set the recording start time to the next rounded half hour from the current time.

The recording and reproducing apparatus may further comprise:

a unit hour setting section, which sets a unit hour;

wherein the recording start time setting section sets the recording start time to a time obtained by rounding up the current time to the next unit hour.

The recording data compression ratio setting section may set the recording data compression ratio based on free space amount of a recording medium considering the other programmed recording which has been set already.

According to the invention, there is also provided a programmed recording method of a recording and reproducing apparatus operable to set a programmed recording of a television program, the programmed recording method comprising:

setting a recording date of the programmed recording to a date of a day on which the programmed recording is set when the programmed recording is commanded;

changing the recording date when the recording date is changing;

setting a recording start time of the programmed recording to the next rounded hour from the current time;

changing the recording start time when the recording start time is changed;

inputting a recording time of the programmed recording;

setting a recording ending time of the programmed recording to a time obtained by adding the input recording time to the recording start time;

changing the recording ending time when the recording ending time is changed;

setting a recording channel of the programmed recording to a channel which is currently received;

changing the recording channel when the recording channel is changed;

setting a recording data compression ratio of the programmed recording based on free space amount of a recording medium considering the other programmed recording which has been set already;

changing the recording data compression ratio when the recording data compression ratio is changed;

storing setup values of the programmed recording; and

setting the programmed recording based on the setup values.

With the above described configurations, the user can easily set the apparatus to programmed recording of any desired TV program by simple operation.

With the above described configurations, the user can easily set the recording start time of the programmed recording to general start time of a TV program, such as every hour on the hour or every half hour on the half hour.

With the above described configurations, the user can selectively set the recording start time of the programmed recording to general start time of a TV program such as every ten minutes.

With the above described configurations, the user can easily set the recording data compression ratio of the programmed recording in accordance with the free space amount of the recording medium.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing the configuration of a recording and reproducing apparatus of an embodiment of the invention;

FIG. 2 is a schematic diagram showing a remote control of the recording and reproducing apparatus;

FIGS. 3a to 3g are diagrams showing display examples of a programmed recording setting screen of the recording and reproducing apparatus; and

FIG. 4 is a flowchart showing a programmed recording setting operation of the recording and reproducing apparatus.

### DETAILED DESCRIPTION OF THE EMBODIMENTS

Hereinafter, embodiments of a recording and reproducing apparatus and a programmed recording method according to the invention will be discussed with reference to the accompanying drawings.

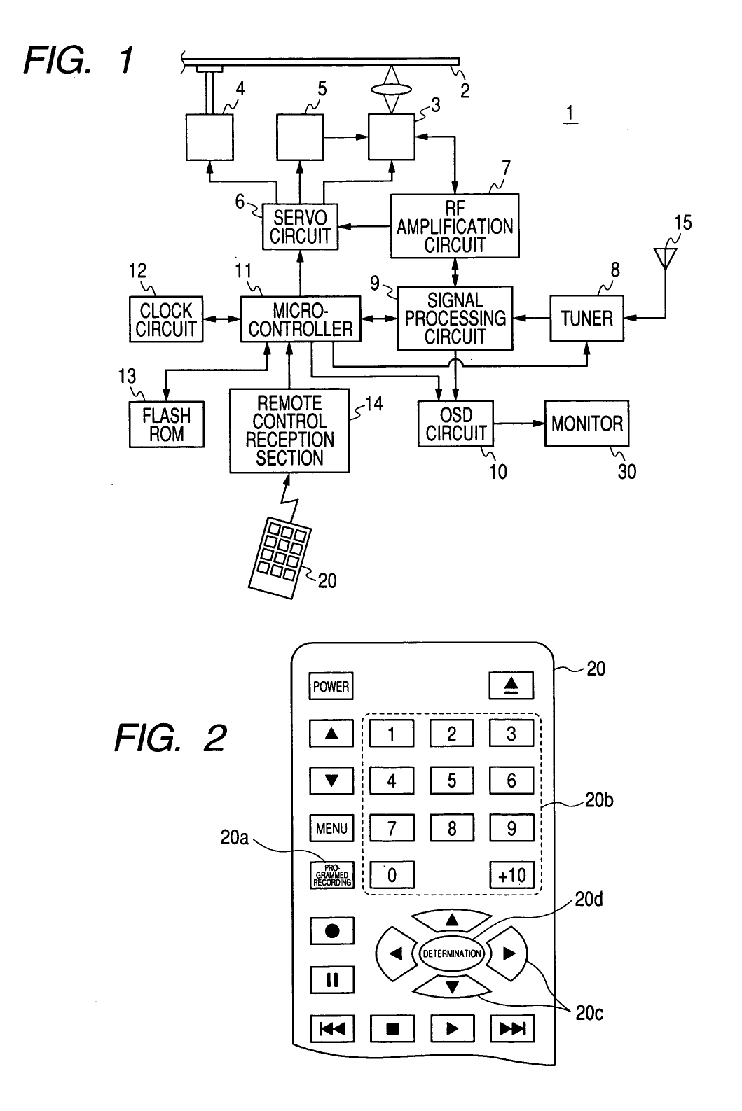

As shown in FIG. 1, the recording and reproducing apparatus 1 is made up of an optical pickup 3 for applying laser light to an optical disk 2, detecting reflected light, and reading video and audio data recorded on the optical disk 2, and also applying laser light to the optical disk 2 for recording video and audio data on the optical disk 2, a spindle motor 4 for turning the optical disk 2, a thread motor 5 for causing the spindle motor 4 to make a thread move in the radial direction of the optical disk 2, a servo circuit 6 for performing servo control of the rotation speed of the spindle motor 4 and the rotation direction and the rotation speed of the thread motor 5 and performing servo control of tracking and focus of the optical pickup 3 based on a tracking error signal and a focus error signal detected by the optical pickup 3, an RF amplification circuit 7 for amplifying an RF (Radio Frequency) signal of the video and audio data read by the optical pickup 3 and also amplifying an RF signal of the video and audio data recorded on the optical disk 2, a turner 8 for receiving TV broadcast of a channel selected from TV radio waves received through an antenna 15, a signal processing circuit 9 for synchronously detecting the RF signal of the video and audio data amplified by the RF amplification circuit 7 based on a reference clock and demodulating the RF signal, correcting an error of the demodulated video and audio data, decompressing the video and audio data compressed according to a predetermined compression system, and decoding the decompressed video and audio data to reproduce the video and audio data and also coding the video and audio data of the TV program received by the tuner 8 and compressing the coded video and audio data according to a predetermined compression system, an OSD (On-Screen Character Display) circuit 10 for displaying character data on a screen of a monitor 30 with a character data signal superposed on a video signal, a microcontroller 11 for controlling the whole system of the recording and reproducing apparatus 1, a clock circuit 12 for managing the date and the time, flash ROM 13 of nonvolatile memory for storing the setup value of programmed recording of a TV program, and a remote control reception section 14 for receiving a remote control signal of an infrared signal transmitted from a remote control 20 and converting the remote control signal into a predetermined electric signal.

As shown in FIG. 2, the remote control 20 is provided with a plurality of operation keys such as a programmed recording key 20a for the user to enter a command for programmed recording of a TV program, a numeric keypad 20b for the user to enter the reception channel of the TV program, cursor keys 20c for the user to select an option on a screen of the monitor 30, and a determination key 20d for determining selection of the option selected with the cursor key 20c. The user can operate the recording and reproducing apparatus 1 as desired by operating the operation keys of the remote control.

The operation of the described recording and reproducing apparatus is as follows.

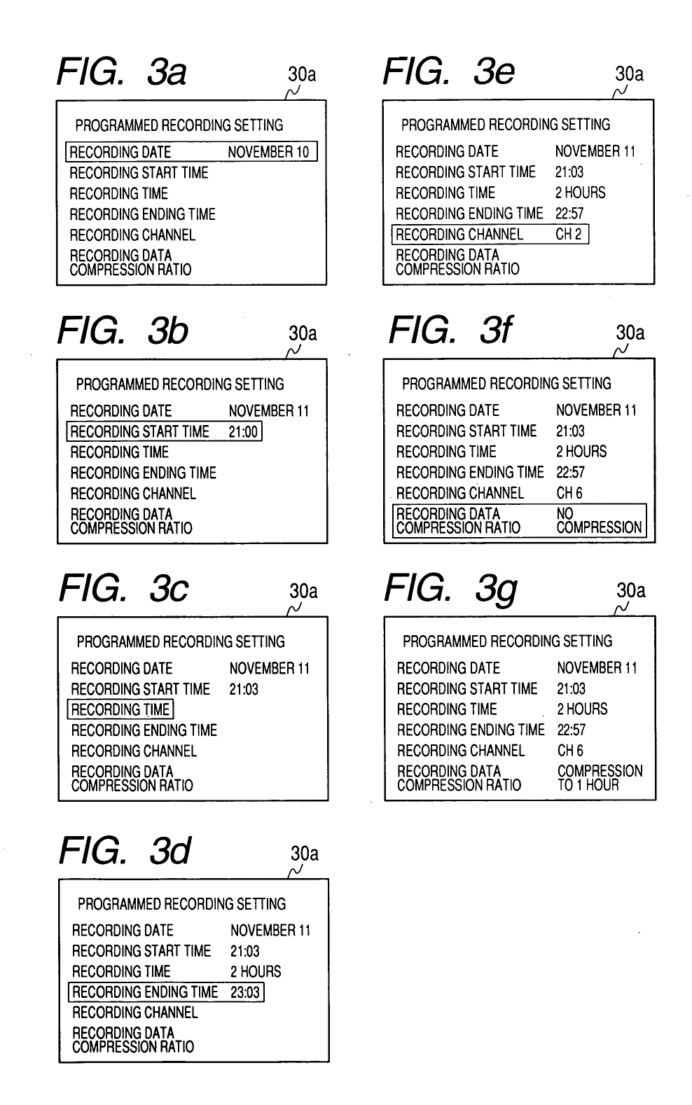

When the user enters a command for programmed recording of a TV program by pressing the programmed recording key 20a, the microcontroller 11 sets the recording date of the programmed recording to the date of a day on which the programmed recording command of the TV program is entered. The microcontroller 11 sends a character data signal and a control signal to the OSD circuit 10, displays a programmed recording setting screen on a screen 30a of the monitor 30, and highlights the recording date of the programmed recording, as shown in FIG. 3a. In FIG. 3a to 3g, highlighting is displayed as a frame. If the user changes the recording date of the programmed recording by operating the cursor key 20c and the determination key 20d of the remote control 20, the microcontroller 11 sends a character data signal and a control signal to the OSD circuit 10 for changing the recording date of the programmed recording.

When the recording date of the programmed recording is set, the microcontroller 11 sets the recording start time of the programmed recording to the next rounded hour from the current time. In this embodiment, the term next rounded hour from the current time represents that the current time is rounded up to every hour on the hour for 24 hours a day. For example, the microcontroller 11 sets the recording start time to 21 hours 00 minutes containing no minutes and no seconds when the current time is 20 hours 18 minutes, and sends a character data signal and a control signal to the OSD circuit 10 for highlighting the recording start time of the programmed recording as shown in FIG. 3b. The micro controller 11 may set the recording start time to the next rounded half hour from the current time. In this case, for example, the microcontroller 11 sets the recording start time to 20 hours 30 minutes containing no seconds when the current time is 20 hours 18 minutes. Furthermore, the user may set a unit hour for rounding up the current time, and the micro controller 11 may set the recording start time to a time obtained by rounding up the current time to the next unit hour. In this embodiment, the term rounding up the current time to the next unit hour represents that the current time is rounded up to every unit hour. In this case, for example, the microcontroller 11 sets the recording start time to 20 hours 20 minutes containing no seconds when the current time is 20 hours 18 minutes in a case where the user sets the unit hour to 10 minutes.

If the user changes the recording start time of the programmed recording by operating the cursor key 20c and the determination key 20d of the remote control 20, the microcontroller 11 sends a character data signal and a control signal to the OSD circuit 10 for changing the recording start time of the programmed recording.

When the recording start time of the programmed recording is set, the microcontroller 11 sends a character data signal and a control signal to the OSD circuit 10 for highlighting the recording time of the programmed recording as shown in FIG. 3c. If the user enters the recording time of the programmed recording by operating the numeric keypad 20b of the remote control 20, the microcontroller 11 sets the recording ending time of the programmed recording to a time obtained by adding the entered recording time to the recording start time, for example, sets the recording ending time of the programmed recording to 23 hours 3 minutes in a case where the recording start time is 21 hours 3 minutes and the entered recording time is two hours, and sends a character data signal and a control signal to the OSD circuit 10 for highlighting the recording ending time of the programmed recording as shown in FIG. 3d. If the user changes the recording ending time of the programmed recording by operating the cursor key 20c and the determination key 20d of the remote control 20, the microcontroller 11 sends a character data signal and a control signal to the OSD circuit 10 for changing the recording ending time of the programmed recording.

When the recording ending time of the programmed recording is set, the microcontroller 11 sets the recording channel of the programmed recording to a channel which is currently received by the tuner 8 and sends a character data signal and a control signal to the OSD circuit 10 for highlighting the recording channel of the programmed recording as shown in FIG. 3e. If the user changes the recording channel of the programmed recording by operating the cursor key 20c and the determination key 20d of the remote control 20, the microcontroller 11 sends a character data signal and a control signal to the OSD circuit 10 for changing the recording channel of the programmed recording.

When the recording channel of the programmed recording is set, the microcontroller 11 sets the recording data compression ratio of the programmed recording based on the free space amount of the optical disk 2 considering the other programmed recording which has been set already, and sends a character data signal and a control signal to the OSD circuit 10 for highlighting the recording data compression ratio of the programmed recording as shown in FIG. 3f If the user changes the recording data compression ratio of the programmed recording by operating the cursor key 20c and the determination key 20d of the remote control 20, the microcontroller 11 sends a character data signal and a control signal to the OSD circuit 10 for changing the recording data compression ratio of the programmed recording.

When setup values of the programmed recording such as the recording date, the recording start time, the recording time, the recording ending time, the recording channel, and the recording data compression ratio are all set as shown in FIG. 3g, the microcontroller 11 stores the setup values of the programmed recording in the flash ROM 13 and sets the programmed recording based on the stored setup values.

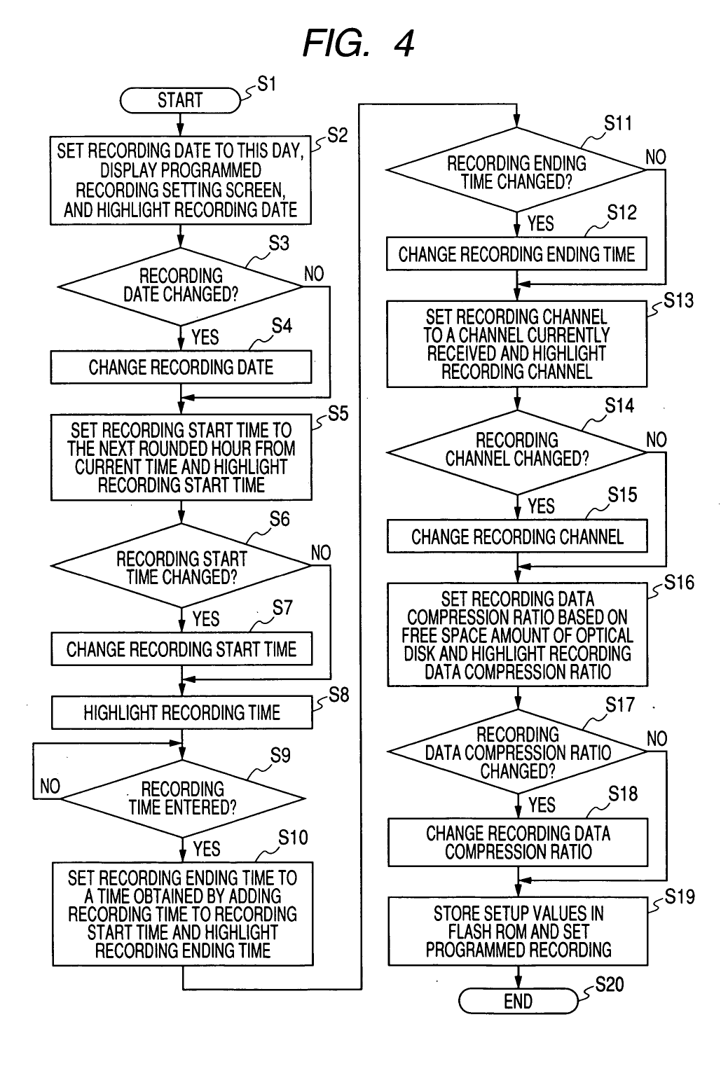

Next, as shown in FIG. 4, the operation of the recording and reproducing apparatus will be discussed.

If the user enters a command for programmed recording of a TV program by pressing the programmed recording key of the remote control, the process goes to step S2 from step S1. At step S2, the recording date of the programmed recording is set to a date of a day on which the programmed recording command of the TV program was entered, a programmed recording setting screen is displayed, the recording date of the programmed recording is highlighted, and the process goes to step S3.

At step. S3, whether or not the user changes the recording date of the programmed recording by operating the cursor key and the determination key of the remote control is determined. If the user changes the recording date of the programmed recording, the process goes to step S4; if the user does not change the recording date of the programmed recording, the process goes to step S5.

At step S4, the recording date of the programmed recording is changed and the process goes to step S5.

At step S5, the recording start time of the programmed recording is set to the next rounded hour from the current time, the recording start time of the programmed recording is highlighted, and the process goes to step S6.

At step S6, whether or not the user changes the recording start time of the programmed recording by operating the cursor key and the determination key of the remote control is determined. If the user changes the recording start time of the programmed recording, the process goes to step S7; if the user does not change the recording start time of the programmed recording, the process goes to step S8.

At step S7, the recording start time of the programmed recording is changed and the process goes to step S8.

At step S8; the recording time of the programmed recording is highlighted and the process goes to step S9.

At step S9, whether or not the user enters the recording time of the programmed recording by operating the numeric keypad of the remote control is determined. If the user enters the recording time of the programmed recording, the process goes to step S10; if the user does not enter the recording time of the programmed recording, step S9 is repeated.

At step S10, the recording ending time of the programmed recording is set to a time obtained by adding the entered recording time to the recording start time, the recording ending time of the programmed recording is highlighted, and the process goes to step S11.

At step S11, whether or not the user changes the recording ending time of the programmed recording by operating the cursor key and the determination key of the remote control is determined. If the user changes the recording ending time of the programmed recording, the process goes to step. S12; if the user does not change the recording ending time of the programmed recording, the process goes to step S13.

At step S12, the recording ending time of the programmed recording is changed and the process goes to step S13.

At step S13, the recording channel of the programmed recording is set to a channel which is currently received by the tuner 8, the recording channel of the programmed recording is highlighted, and the process goes to step S14.

At step S14, whether or not the user changes the recording channel of the programmed recording by operating the cursor key and the determination key of the remote control is determined. If the user changes the recording channel of the programmed recording, the process goes to step S15; if the user does not change the recording channel of the programmed recording, the process goes to step S16.

At step S15, the recording channel of the programmed recording is changed and the process goes to step S16.

At step S16, the recording data compression ratio of the programmed recording is set based on the free space amount of the optical disk considering the other programmed recordings which have been set already, the recording data compression ratio of the programmed recording is highlighted, and the process goes to step S17.

At step S17, whether or not the user changes the recording data compression ratio of the programmed recording by operating the cursor key and the determination key of the remote control is determined. If the user changes the recording data compression ratio of the programmed recording, the process goes to step S18; if the user does not change the recording data compression ratio of the programmed recording, the process goes to step S19.

At step S18, the recording data compression ratio of the programmed recording is changed and the process goes to step S19.

At step S19, the setup values of the programmed recording are stored in the flash ROM, the programmed recording is set based on the stored setup values, the process goes to step S20, and the processing is terminated.

Although the embodiment for carrying out the invention has been described in detail, it is to be understood that the invention is not limited to the embodiment, and the modifications and the improvements are possible within the usual knowledge of those skilled in the art. For example, the recording and reproducing apparatus sets to programmed recording of a TV program on an optical disk, but the invention can also be applied to any other recording and reproducing apparatus sets to programmed recording of a TV program on a record medium such as video cassette tape or a hard disk, needless to say.

What is claimed is:

1. A recording and reproducing apparatus operable to set a programmed recording of a television program, the recording and reproducing apparatus comprising:
recording date setting means for setting a recording date of the programmed recording to a date of a day on which the programmed recording is set when the programmed recording is commanded;
recording date changing means for changing the recording date set by the recording date setting means;
recording start time setting means for setting a recording start time of the programmed recording to the next rounded hour from the current time;
recording start time changing means for changing the recording start time set by the recording start time setting means;
recording time input means for inputting recording time of the programmed recording;
recording ending time setting means for setting a recording ending time of the programmed recording to a time obtained by adding the recording time input by the recording time input means to the recording start time;
recording ending time changing means for changing the recording ending time set by the recording ending time setting means;
recording channel setting means for setting a recording channel of the programmed recording to a channel which is currently received;
recording channel changing means for changing the recording channel set by the recording channel setting means;
recording data compression ratio setting means for setting a recording data compression ratio of the programmed recording based on free space amount of a recording medium considering the other programmed recording which has been set already;
recording data compression ratio changing means for changing the recording data compression ratio set by the recording data compression ratio setting means; and
programmed recording setting means for storing setup values of the programmed recording and setting the programmed recording based on the setup values.

2. A recording and reproducing apparatus operable to set a programmed recording of a television program, the recording and reproducing apparatus comprising:
a recording date setting section, which sets a recording date of the programmed recording to a date of a day on which the programmed recording is set when the programmed recording is commanded;
a recording date changing section, which changes the recording date set by the recording date setting section;
a recording start time setting section, which sets a recording start time based on the current time;
a recording start time changing section, which changes the recording start time set by the recording start time setting section;
a recording time input section, which inputs recording time of the programmed recording;
a recording ending time setting section, which sets a recording ending time of the programmed recording to a time obtained by adding the recording time input by the recording time input section to the recording start time;
a recording ending time changing section, which changes the recording ending time set by the recording ending time setting section;
a recording channel setting section, which sets the recording channel of the programmed recording to a channel which is currently received;
a recording channel changing section, which changes the recording channel set by the recording channel setting means;
a recording data compression ratio setting section, which sets the recording data compression ratio of the programmed recording;
a recording data compression ratio changing section, which changes the recording data compression ratio set by the recording data compression ratio setting section;
a programmed recording setting section, which stores the recording date, the recording start time, the recording ending time, the recording channel, and the recording data compression ratio and sets the programmed recording based on the stored recording date, the stored recording start time, the stored recording ending time, the stored recording channel, and the stored recording data compression ratio.

3. The recording and reproducing apparatus as set forth in claim 2, wherein the recording start time setting section sets the recording start time to the next rounded hour from the current time.

4. The recording and reproducing apparatus as set forth in claim 2, wherein the recording start time setting section sets the recording start time to the next rounded half hour from the current time.

5. The recording and reproducing apparatus as set forth in claim 2, further comprising:
a unit hour setting section, which sets a unit hour;
wherein the recording start time setting section sets the recording start time to a time obtained by rounding up the current time to the next unit hour.

6. The recording and reproducing apparatus as set forth in claim 2, wherein the recording data compression ratio setting section sets the recording data compression ratio based on free space amount of a recording medium considering the other programmed recording which has been set already.

7. A programmed recording method of a recording and reproducing apparatus operable to set a programmed recording of a television program, the programmed recording method comprising:
setting a recording date of the programmed recording to a date of a day on which the programmed recording is set when the programmed recording is commanded;
changing the recording date when the recording date is changing;
setting a recording start time of the programmed recording to the next rounded hour from the current time;
changing the recording start time when the recording start time is changed;
inputting a recording time of the programmed recording;
setting a recording ending time of the programmed recording to a time obtained by adding the input recording time to the recording start time;
changing the recording ending time when the recording ending time is changed;
setting a recording channel of the programmed recording to a channel which is currently received;
changing the recording channel when the recording channel is changed;
setting a recording data compression ratio of the programmed recording based on free space amount of a recording medium considering the other programmed recording which has been set already;
changing the recording data compression ratio when the recording data compression ratio is changed;
storing setup values of the programmed recording; and
setting the programmed recording based on the setup values.
